(19) United States
(12) Patent Application Publication
(10) Pub. No.: US 2012/0068958 A1
(43) Pub. Date: Mar. 22, 2012

(54) PORTABLE ELECTRONIC DEVICE AND CONTROL METHOD THEREOF

(75) Inventor: WEI-HAO CHEN, Tu-Cheng (TW)

(73) Assignee: CHI MEI COMMUNICATION SYSTEMS, INC., Tu-Cheng City (TW)

(21) Appl. No.: 12/940,011

(22) Filed: Nov. 4, 2010

(30) Foreign Application Priority Data
Sep. 21, 2010 (TW) 99131933

(51) Int. Cl. G09G 5/10; G06F 3/045

(52) U.S. Cl. 345/174; 345/173

(57) ABSTRACT

A portable electronic device and method executes control functions by variations of a light intensity. The portable electronic device comprises a memory, a touch screen, a proximity sensor and at least one processor. The light sensor detects an original light intensity and a current light intensity surrounding the portable electronic device when the touch screen is turned on. If a difference in light intensity between the original light intensity and the current light intensity is more than a predetermined value, the portable electronic device controls a user interface displayed in the touch screen accordingly.

### BACKGROUND

1. Technical Field

Embodiments of the present disclosure relate to device operation, and more particularly to a portable electronic device and a control method for the portable electronic device.

2. Description of Related Art

Physical controls, such as buttons or keys, of an electronic device are commonly used. However, if the portable electronic device is a touch screen device, control of the touch screen device is executed by contact with the display, as with PDAs and smart phones. However, repeated activation of the controls and contact with the touch screen can impair the responsiveness of the touch screen.

### BRIEF DESCRIPTION OF THE DRAWINGS

FIG. 1 is a block diagram of one embodiment of a portable electronic device.

FIG. 2 is a schematic diagram of one embodiment of the portable electronic device.

FIG. 3 is a flowchart of one embodiment of a method for controlling a portable electronic device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used herein, refers to logic embodied in hardware or firmware, or to a collection of software instructions, written in a programming language, such as, for example, Java, C, or Assembly. One or more software instructions in the module may be embedded in firmware, such as an EPROM. It will be appreciated that module may comprise connected logic units, such as gates and flip-flops, and may comprise programmable units, such as programmable gate arrays or processors. The module described herein may be implemented as either software and/or hardware module and may be stored in any type of computer-readable medium or other computer storage device.

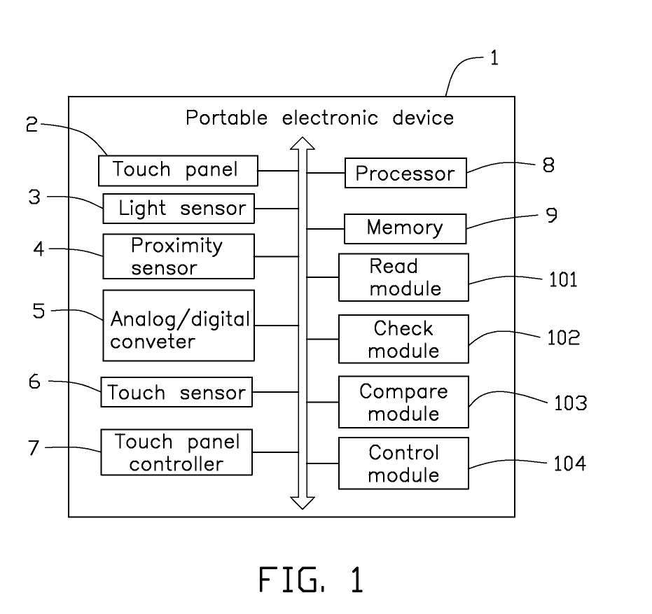

FIG. 1 is a block diagram of one embodiment of a portable electronic device 1. Depending on the embodiment, the portable electronic device 1 may be a mobile phone, a personal digital assistant (PDA), a handheld game console, a digital camera (DC), a handheld computer, or other device. The portable electronic device 1 includes a touch screen 2, a light sensor 3, a proximity sensor 4, an analog/digital converter 5, a contact sensor 6, a touch screen controller 7, at least one processor 8, a memory 9, and one or more programs including a recording module 101, a confirmation module 102, a comparison module 103 and a control module 104.

The portable electronic device 1 is generally controlled and coordinated by an operating system software, such as UNIX, LINUX, WINDOWS, MAC OS X, an embedded operating system, or any other compatible operating systems. In other embodiments, the portable electronic device 1 may be controlled by a proprietary operating system. Conventional operating systems control and schedule computer processes for execution, perform memory management, provide file system, networking, and I/O services, and provide a user interface, such as a graphical user interface (GUI), among other things.

The touch screen 2 is operable to receive at least one contact contacting the touch screen 2, and display information of the portable electronic device 1. In one embodiment, a stylus or a finger can be used with the touch screen 2. The touch screen 2 can be a resistive touch screen or a capacitive touch screen.

The touch screen controller 7 is operable to generate at least one coordinate value of the at least one contact on the touch screen 2. In one embodiment, the user can contact the touch screen 2 using multiple simultaneous contacts. The touch screen controller 7 can detect one or more contacts in two or three locations on the touch screen 2 at the same time to generate two or three coordinate values of the one or more contacts to the contact sensor 6.

The contact sensor 6 is operable to detect whether at least one contact occurs on the touch screen 2. The touch screen controller 7 generates at least one coordinate value of the at least one contact on the touch screen 2 to the contact sensor 6. The contact sensor 6 can determine if contact is made not made with the touch screen 2 based on the at least one coordinate value.

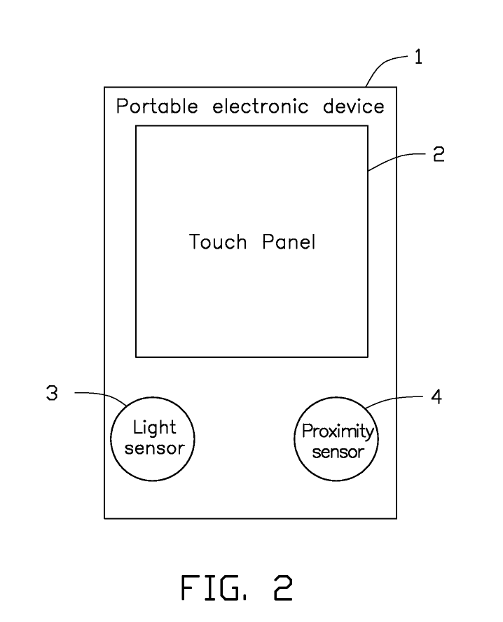

The light sensor 3 is operable to detect a variation in light intensity of light surrounding the portable electronic device 1 and output a number of analog signals corresponding to the detected variation to the analog/digital converter 5. In one embodiment, the light sensor 3 can be configured beside the touch screen 2. As shown in FIG. 2, the light sensor 3 is disposed at the bottom of touch screen 2. In other embodiments, the light sensor 3 can be disposed at the right side, left side, or top of the touch screen 2. The light sensor 3 is able to detect variations in light intensity of light in front of the portable electronic device 1.

The proximity sensor 4 is operable to detect the presence of an object near the portable electronic device 1 and output digital signals to the confirmation module 102.

For example, if the proximity sensor 4 detects an object, a digital signal “1” is output to the confirmation module 102. If no object is detected, a digital signal “0” is output. As shown in FIG. 2, the proximity sensor 4 is disposed at the bottom of the touch screen 2. In other embodiments, the proximity sensor 4 further can be disposed at the right side, left side and top of the touch screen 2.

The analog/digital converter 5 is operable to transform the analog signals of the detected variation of light intensity into digital signals. The digital signals are then saved in the memory 9.

The modules 101-104 may comprise computerized code in the form of one or more programs that are stored in the memory 9. The computerized code includes instructions that are executed by the at least one processor 8 to provide functions for modules 101-104. The at least one processor 8, as an example, may include a CPU, math coprocessor, shift register, for example.

The memory 9 is electronically connected to the touch screen 2, the light sensor 3, the proximity sensor 4, the analog/digital converter 5, the contact sensor 6, the touch screen controller 7, the at least one processor 8, the recording module 101, the confirmation module 102, the comparison module 103 and the control module 104. The memory 9 is operable to store many kinds of data, such as a customization function code of the portable electronic device 1, computerized codes, programs of an operating system and other applications of the portable electronic device 1. The memory 9 may include a hard disk drive, flash memory, RAM, ROM, cache, or external storage mediums.

The recording module 101 is operable to save the digital signal indicative of light intensity to the memory 9. In one embodiment, the recording module 101 saves the digital signal indicative of light intensity as an original light intensity when the touch screen 2 is turned on. Furthermore, the recording module 101 saves the digital signal indicative of light intensity as a current light intensity. In other embodiments, when the touch screen 2 is turned on, the recording module 101 saves the digital signal indicative of light intensity as the current light intensity to the memory 9 for every one of the preset time intervals. For example, the preset time interval is 0.1 seconds.

The confirmation module 102 is operable to determine if the object is proximate to the proximity sensor 4. In one example, “proximate” is defined as an object, such as a finger or a stylus, being a certain distance away from the proximity sensor 4. The proximity sensor 4 can detect the fingers proximate to the portable electronic device 1 to output the digital signals to the confirmation module 102.

The comparison module 103 is operable to calculate a difference of light intensity between the current light intensity and the original light intensity. The comparison module 103 further determines whether the difference of light intensity is more than a predetermined value. If so, the comparison module 103 further saves the difference of light intensity to the memory 9. Otherwise, the difference of light intensity is reset to zero.

The control module 104 is operable to control a user interface displayed in the touch screen 2 according to the difference of light intensity received from the comparison module 103. In one embodiment, the control module 104 can increase the resolution of the display in the touch screen 2 in response to the difference of light intensity received from the comparison module 103 of a positive value. Conversely, the control module 104 can decrease the display resolution if the difference of light intensity received from the comparison module 103 is a negative value.

In other embodiments, if the difference of light intensity received from the comparison module 103 is a positive value, the control module 104 can scroll up on a scrolling bar of display. If the difference of light intensity received from the comparison module 103 is a negative value, the control module 104 can scroll downward.

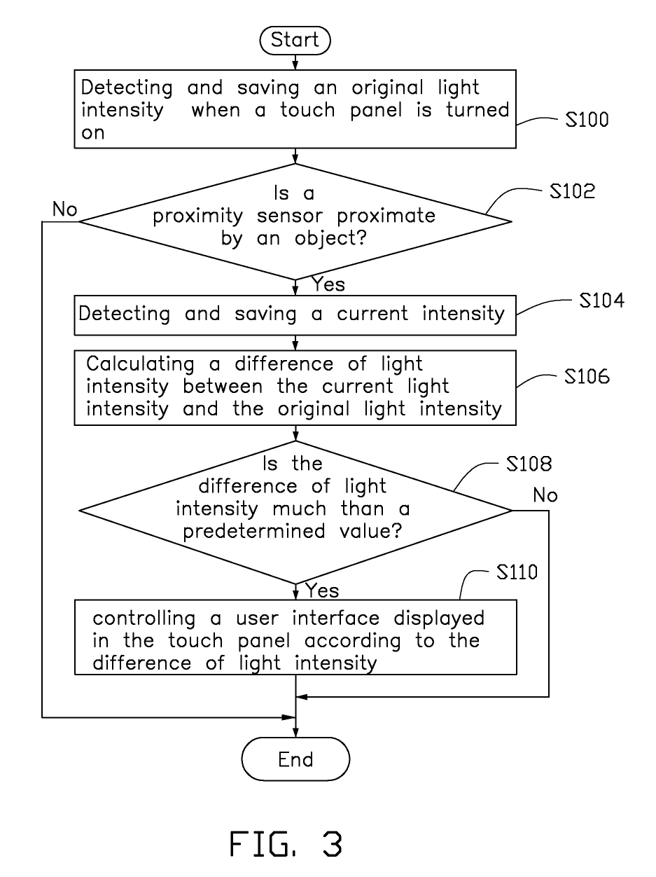

FIG. 3 is a flowchart of one embodiment of a method for controlling a portable electronic device 1. Depending on the embodiment, additional blocks may be added, others deleted, and the ordering of the blocks may be changed.

In block S100, when the touch screen 2 is turned on, the light sensor 3 detects an original light intensity surrounding the portable electronic device 1 to generate an analog signal of light intensity, which is saved to the memory 9.

In block S102, the confirmation module 102 determines whether the proximity sensor 4 is proximate by an object. If the proximity sensor 4 is proximate, block S104 is implemented. If proximity sensor 4 is not proximate, the process is complete. In one embodiment, if the proximity sensor 4 detects the object, the proximity sensor 4 outputs a digital signal “1” to the confirmation module 102. If no object is detected, the proximity sensor 4 outputs a digital signal “0” to the confirmation module 102.

In block S104, the light sensor 3 detects a current light intensity surrounding the portable electronic device 1 and saves the current light intensity to the memory 9.

In block S106, the comparison module 103 calculates a difference of light intensity between the current light intensity and the original light intensity and saves the difference of light intensity to the memory 9;

In block S108, the comparison module 103 determines whether the difference of light intensity is more than a predetermined value. If the difference of light intensity is more than a predetermined value, the comparison module 103 determines light intensity is changed and block S110 is implemented. If the difference of light intensity is less than a predetermined value, the comparison module 103 determines light intensity has not changed and the process is complete.

In block S110, the control module 104 controls a user interface displayed in the touch screen 2 according to the difference of light intensity received from the comparison module 103. In one embodiment, the control module 104 can increase resolution of the display of the touch screen 2 if the difference of light intensity received from the comparison module 103 is a positive value. If the difference of light intensity received from the comparison module 103 is a negative value, the control module 104 can decrease resolution of the display on the touch screen 2. In other embodiments, if the difference of light intensity received from the comparison module 103 is a positive value, the control module 104 can scroll the display.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A portable electronic device, comprising:
a memory;
at least one processor;
a touch screen;
a light sensor;
a proximity sensor;
a comparison module operable to calculate a difference of light intensity between a current light intensity and an original light intensity detected by the light sensor in response to an object being proximate to the proximity sensor; and
a control module operable to control a user interface displayed in the touch screen according to the difference of light intensity.

2. The portable electronic device of claim 1, further comprising:
a contact sensor operable to detect whether at least one contact occurs on the touch screen;
a touch screen controller operable to generate at least one coordinate value of the at least one contact on the touch screen;

3. The portable electronic device of claim 1, wherein the comparison module further determines whether the difference of light intensity is more than a predetermined value.

4. The portable electronic device of claim 1, wherein the recording module further saves digital signals indicative of the light intensity to the memory within a preset time interval when the touch screen is turned on.

5. The portable electronic device of claim 1, wherein the touch screen is a resistive touch screen or a capacitive touch screen.

6. A method for controlling a portable electronic device, the portable electronic device comprising a touch screen, a proximity sensor, a light sensor and at least one processor, the method comprising:
detecting an original light intensity surrounding the portable electronic device using the light sensor when the touch screen is turned on;
determining if an object is proximate to the proximity sensor;
detecting a current light intensity surrounding the portable electronic device using the light sensor within a preset time interval in response to the object being proximate to the proximity sensor;
calculating a difference of light intensity between the current light intensity and the original light intensity; and
controlling a user interface displayed in the touch screen according to the difference of light intensity.

7. The method of claim 6, wherein the step of controlling the user interface scrolls a scroll bar of a browser or zooms images displayed in the user interface.

8. The method of claim 6, further comprising determining if the difference of light intensity is more than a predetermined value.

9. The method of claim 6, further comprising saving the difference of light intensity in the memory.

10. The method of claim 6, further comprising saving digital signals indicative of the light intensity to the memory within a preset time interval when the touch screen is turned on.

11. A storage medium having stored thereon instructions that, when executed by a processor, causes the processor to perform a method for controlling a portable electronic device, the portable electronic device comprising a touch screen, a proximity sensor, a light sensor and at least one processor, the method comprising:
detecting an original light intensity surrounding the portable electronic device using the light sensor when the touch screen is turned on;
determining if an object is proximate to the proximity sensor;
detecting a current light intensity surrounding the portable electronic device using the light sensor within a preset time interval in response to the object being proximate to the proximity sensor;
calculating a difference of light intensity between the current light intensity and the original light intensity; and
controlling a user interface displayed in the touch screen according to the difference of light intensity.

12. The storage medium of claim 11, wherein the step of controlling the user interface scrolls a scroll bar of a browser or zooms images displayed in the user interface.

13. The storage medium of claim 11, wherein the method further comprising determining if the difference of light intensity is more than a predetermined value.

14. The storage medium of claim 11, wherein the method further comprising saving the difference of light intensity in the memory.

15. The storage medium of claim 11, wherein the method further comprising saving digital signals indicative of the light intensity to the memory within a preset time interval when the touch screen is turned on.
